(19) United States
(12) Patent Application Publication
(10) Pub. No.: US 2025/0300567 A1
(43) Pub. Date: Sep. 25, 2025

(54) EXTENDED CONVERSION RATIO MODULATION FOR SYMMETRIC SERIES-CAPACITOR BUCK

(71) Applicant: VIRGINIA TECH INTELLECTUAL PROPERTIES, INC., Blacksburg, VA (US)

(72) Inventors: Xinmiao Xu, Blacksburg, VA (US); Qiang Li, Blacksburg, VA (US)

(21) Appl. No.: 19/087,818

(22) Filed: Mar. 24, 2025

Related U.S. Application Data
(60) Provisional application No. 63/568,601, filed on Mar. 22, 2024.

(51) Int. Cl. H02M 3/335; H02M 1/00

(52) U.S. Cl. CPC H02M 3/33592; H02M 1/0095

(57) ABSTRACT

An example power converter system includes a power converter including a first phase leg and a second phase leg. The first phase leg includes a first plurality of switches including a first switch, a second switch, and a third switch, and the second phase leg includes a second plurality of switches including a fourth switch, a fifth switch, and a sixth switch. The power converter system further includes a controller configured to control operations of the power converter for converting an input direct current (DC) voltage to an output DC voltage. The operations include, for a switching period of the power converter, sequentially turning on one or more switches of the first plurality of switches and sequentially turning on one or more switches of the second plurality of switches after sequentially turning on the one or more switches of the first plurality of switches.

### CROSS-REFERENCE TO RELATED APPLICATIONS

This application claims the benefit of and priority to U.S. Provisional Patent Application No. 63/568,601, filed Mar. 22, 2024, entitled “EXTENDED-CONVERSION-RATIO MODULATION FOR SYMMETRIC SERIES-CAPACITOR BUCK,” the entire content of which is hereby incorporated herein by reference in its entirety.

### BACKGROUND

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

Multi-phase synchronous buck converters can be used as a non-isolated DC to DC converter for voltage step-down conversion. However, these converters can exhibit lower efficiency when exposed to smaller conversion ratios of output voltage to input voltage. This lower efficiency is attributable to semiconductor switches in these converters, which can have large off-state voltage stresses.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts a power converter system for applying switching modulation techniques to a power converter according to one or more embodiments of the present disclosure.

FIG. 2 depicts a timing diagram of switching control signals of a conventional modulation technique applied to the power converter shown in FIG. 1.

FIG. 3 depicts voltage and current waveforms of various components in the power converter shown in FIG. 1, with the conventional modulation technique applied

FIG. 4 depicts a timing diagram of switching control signals of a first modulation technique applied to the power converter shown in FIG. 1, according to one or more embodiments of the present disclosure.

FIG. 5 depicts voltage and current waveforms of various components in the power converter shown in FIG. 1 with the first modulation technique shown in FIG. 4 applied, according to one or more embodiments of the present disclosure.

FIG. 6 depicts a timing diagram of switching control signals of the first modulation technique for a different conversion ratio applied to the power converter shown in FIG. 1, according to one or more embodiments of the present disclosure.

FIG. 7 depicts voltage and current waveforms of various components in the power converter shown in FIG. 1 with the first modulation technique shown in FIG. 6 applied, according to one or more embodiments of the present disclosure.

FIG. 8 depicts a timing diagram of switching control signals of a second modulation technique applied to the power converter shown in FIG. 1, according to one or more embodiments of the present disclosure.

FIG. 9 depicts voltage and current waveforms of various components in the power converter shown in FIG. 1 with the second modulation technique shown in FIG. 8 applied, according to one or more embodiments of the present disclosure.

FIG. 10 depicts a timing diagram of switching control signals of the second modulation technique for a different conversion ratio and applied to the power converter shown in FIG. 1, according to one or more embodiments of the present disclosure.

FIG. 11 depicts voltage and current waveforms of various components in the power converter shown in FIG. 1 with the second modulation technique shown in FIG. 10 applied, according to one or more embodiments of the present disclosure.

FIG. 12 depicts a timing diagram of switching control signals of the second modulation technique for a different conversion ratio and applied to the power converter shown in FIG. 1, according to one or more embodiments of the present disclosure.

FIG. 13 depicts voltage and current waveforms of various components in the power converter shown in FIG. 1 with the second modulation technique shown in FIG. 12 applied, according to one or more embodiments of the present disclosure.

FIG. 14 depicts a timing diagram of switching control signals of a third modulation technique applied to the power converter shown in FIG. 1, according to one or more embodiments of the present disclosure.

FIG. 15 depicts voltage and current waveforms of various components in the power converter shown in FIG. 1 with the third modulation technique shown in FIG. 14 applied, according to one or more embodiments of the present disclosure.

FIG. 16 depicts a timing diagram of switching control signals of the third modulation technique for a different conversion ratio and applied to the power converter shown in FIG. 1, according to one or more embodiments of the present disclosure.

FIG. 17 depicts voltage and current waveforms of various components in the power converter shown in FIG. 1 with the third modulation technique shown in FIG. 16 applied, according to one or more embodiments of the present disclosure.

### DETAILED DESCRIPTION

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

Multi-phase synchronous buck converters can be used as a non-isolated DC to DC converter for voltage step-down conversion. However, these converters can exhibit lower efficiency when exposed to smaller conversion ratios of output voltage to input voltage. This lower efficiency is attributable to semiconductor switches in these converters, which can have large off-state voltage stresses. One common or conventional solution is to incorporate a transformer into the buck converter and form transformer-isolated buck converters, such as a forward converter or a full-bridge converter. These converters rely on transformer turns ratio to reduce transistor voltage stress and assist in voltage step-down conversion. However, leakage inductors of a transformer usually create considerable ringing on transistor off-state voltages and induce significant power loss. Also, a transformer itself occupies notable printed-circuit board (PCB) footprint, which increases the size and cost of the isolated DC to DC converter. For at least these reasons, both efficiency and power density of transformer-isolated buck converters are limited.

Another conventional solution is to use capacitors and form hybrid switched-capacitor converters, such as in asymmetric and symmetric series-capacitor buck converters for example. One limitation of the symmetric series-capacitor buck, with conventional modulation techniques applied, is a limited range of the output voltage, which can range from zero and up to a quarter of the input voltage. This limits the application of the symmetric series-capacitor buck topology. For example, the input voltage to IT gears in modern data centers can be as low as 40 V, and the conventional modulation techniques cannot generate a 12 V output from a 40 V input. In practice, the conventional modulation techniques cannot even achieve 48V-to-12V conversion due to the conduction loss of the power converter.

Therefore, various embodiments of the present disclosure are directed to modulation techniques or schemes for controlling switching operations of a two-phase symmetric series-capacitor buck (SCB) converter for extended conversion ratio modulations, although the described modulation techniques can be applied to other types of power converters as well. The embodiments can achieve a voltage conversion ratio of the converter ranging from zero and up to one-third, although other conversion ratios can also be achieved. Within the conversion ratio range, the maximum off-state voltage stress on rectifier switches is generally half of the input voltage. In the switching modulation techniques described herein, voltage-capacitor branches are not connected in parallel, which eliminates associated charge-sharing loss. In practice, the modulation techniques can have voltage-capacitor branches connected in parallel for an extremely short amount of time, such as ten nanoseconds according to one example. Compared to conventional techniques, the charge-sharing loss is reduced to a large extent.

In the context outlined above, one embodiment includes a power converter system which includes a power converter including a first phase leg and a second phase leg. The first phase leg includes a first plurality of switches including a first switch, a second switch, and a third switch. The second phase leg includes a second plurality of switches including a fourth switch, a fifth switch, and a sixth switch. The embodiment further includes a controller configured to control operations of the power converter for converting an input DC voltage to an output DC voltage. The operations include, for a switching period of the power converter, sequentially turning on one or more switches of the first plurality of switches of the first phase leg. The operations further include sequentially turning on one or more switches of the second plurality of switches of the second phase leg after sequentially turning on the one or more switches of the first plurality of switches.

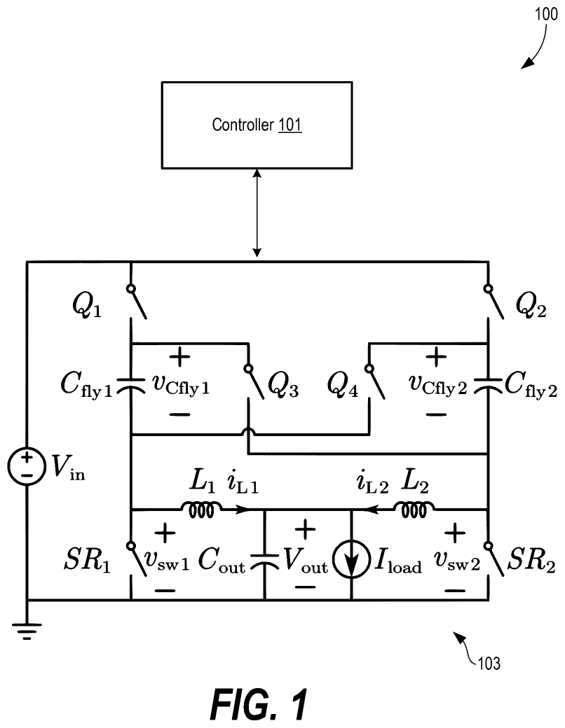

Referring now to the drawings, FIG. 1 depicts a power converter system 100 for applying switching modulation techniques to a power converter according to one or more embodiments of the present disclosure. The power converter system 100 includes a power converter 103 and a controller 101, where the controller 101 is configured to control switching operations of the power converter 103. The power converter system 100 is not exhaustively illustrated, meaning that other components not shown in FIG. 1 can be included or relied upon in some cases. Similarly, one or more components shown in FIG. 1 can be omitted in some cases.

The power converter 103 is a two-phase symmetric SCB converter and includes six switches Q₁, Q₂, Q₃, Q₄, SR₁ and SR₂, two flying capacitors C_{fly1} and C_{fly2}, two output inductors L₁ and L₂, and an output capacitor Cout connected across a current load I_{load}. The switches Q₁, Q₂, Q₃, Q₄, SR₁ and SR₂ can be implemented with n-channel enhancement-mode silicon metal-oxide-semiconductor field-effect transistors (MOSFETs). However, the switches Q₁, Q₂, Q₃, Q₄, SR₁ and SR₂ can also be implemented with gallium nitride transistors or other semiconductor switches. The switching modulation techniques according to the embodiments are described with respect to the power converter 103. The switching modulation techniques described herein are not limited to use with the specific type of power converter depicted by the power converter 103 and can be applied to a wide range of power converters.

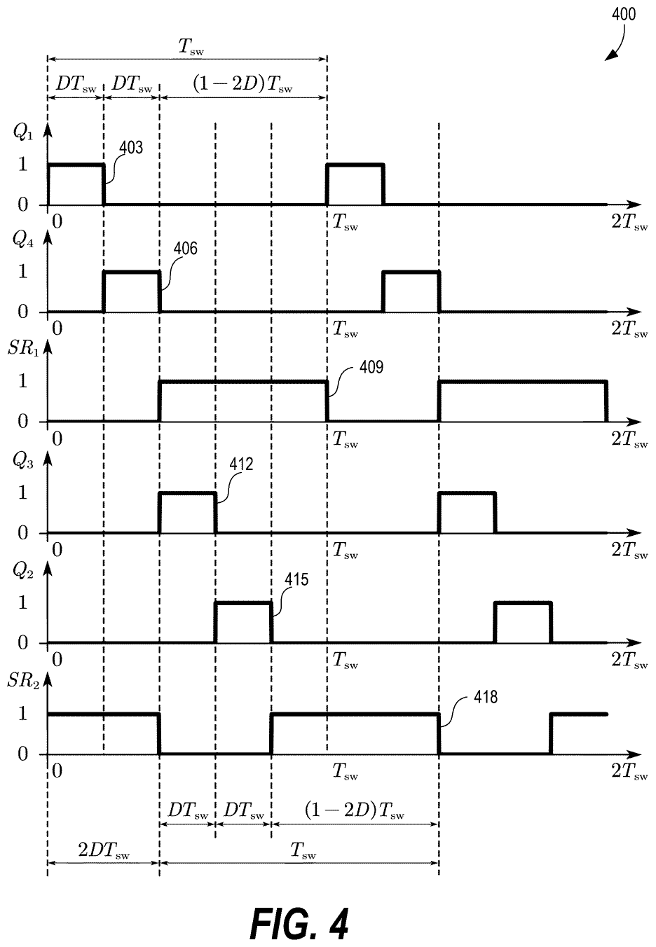

The power converter 103 includes two phase legs, with each phase leg including three switches. For example, a first phase leg includes the switches Q₁, Q₄, and SR₁. A second phase leg includes the switches Q₃, Q₂, and SR₂. The switches SR₁ and SR₂ are synchronous rectifier (SR) switches and are complementary to the switches in their respective phase legs. The controller 101 can be configured to generate switching control signals for the switches of each phase leg for converting an input voltage Vᵢₙ to an output voltage Vₒᵤₜ of the power converter 103. Thus, the controller 101 can direct the switching (i.e., current or power flow) operations of the aforementioned switching devices or switches. Example operating frequencies for the power converter 103 can range from tens of kHz to several MHz or higher. The switching devices and operation of the power converter 103 can be controlled by pulse width modulation (PWM) control signals generated by the controller 101, according to one example. In the switching modulation techniques, the controller 101 can be configured to activate or turn on the switches Q₁, Q₄, and SR₁ of the first phase leg with a time shift from activation of the switches Q₃, Q₂, and SR₂ of the second phase leg. In other words, corresponding switches of each phase leg, such as the switch Q₁ and the switch Q₃, and the switch Q₄ and the switch Q₂, may be activated or turned on with a time shift as compared to each other. These techniques are described in further detail with respect to the timing diagrams depicted in FIGS. 4, 6, 8, 10, 12, 14 and 16.

The controller 101 can be embodied as processing circuitry, including memory, configured to control operation of the power converter 103, with or without feedback. The controller 101 can be embodied as any suitable type of controller, such as a proportional integral derivative (PID) controller, a proportional integral (PI) controller, or a multi-pole multi-zero controller, among others, to control the operations of the power converter 103. The controller 101 can be realized using a combination of processing circuitry and referenced as a single controller. It should be appreciated, however, that the controller 101 can be realized using a number of controllers, control circuits, drivers, and related circuitry, operating with or without feedback.

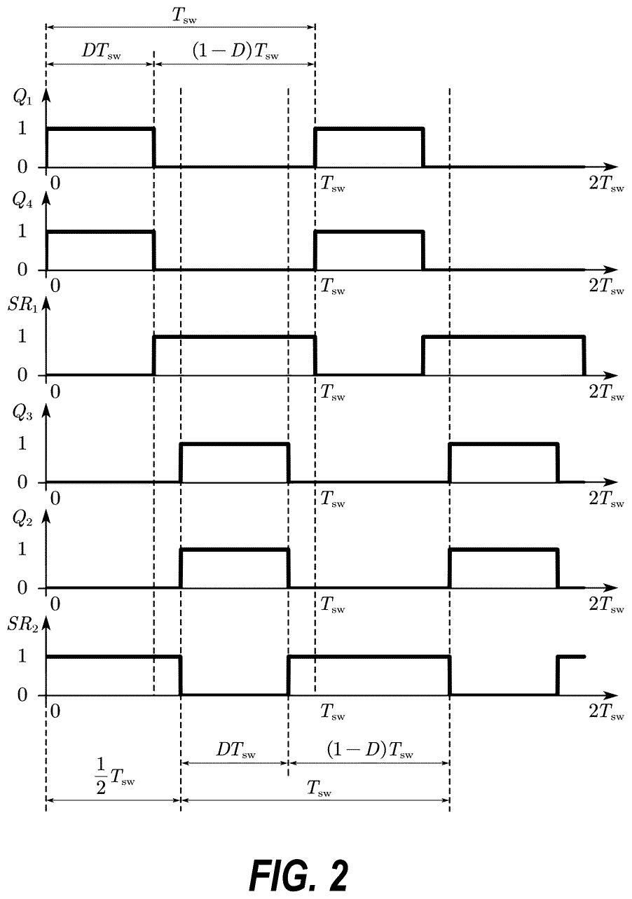

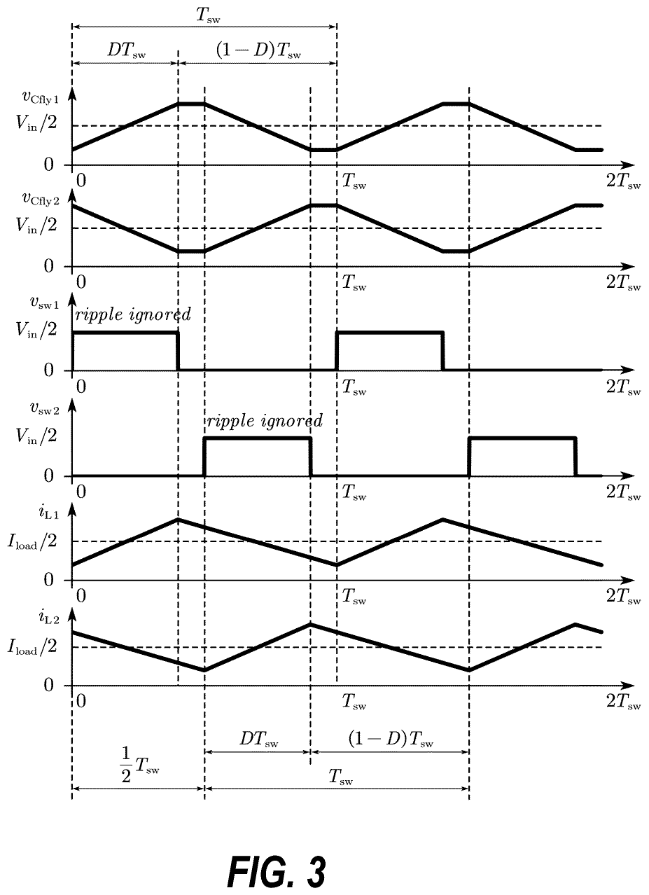

FIG. 2 depicts a timing diagram of switching control signals of a conventional modulation technique applied to the power converter shown in FIG. 1, and FIG. 3 depicts voltage and current waveforms of various components in the power converter shown in FIG. 1, with the conventional modulation technique applied. In FIG. 2, the switches Q₁ and Q₄ of the first phase leg are concurrently activated or turned on at the same time in a switching period T_{sw}. Additionally, the switches Q₃ and Q₂ of the second phase leg are turned on at the same time but phase shifted by 180 degrees (i.e. time-shifted by T_{sw}/2, half of a switching period) from the activation signals of the switches Q₁ and Q₄. Thus, the maximum duty ratio can be expressed by equation 1 below:

$${D}_{m ax , conventional} = \frac{1}{2} \qquad ( 1 )$$

Additionally, the conversion ratio of Vₒᵤₜ to Vᵢₙ can be expressed by equation 2 below, when the conventional modulation technique shown in FIG. 2 is applied to the power converter 103:

$${M}_{conventional} = \frac{{V}_{out}}{{V}_{i n}} = \frac{1}{2} {D}_{c onventional} \qquad ( 2 )$$

Therefore, the maximum conversion ratio for the conventional modulation technique is one-fourth, which is a limitation of the conventional modulation technique. This limitation limits the application of the power converter 103. For example, the input voltage to information technology (IT) gears or devices in modern data centers can be as low as 40 V, and the conventional modulation technique cannot generate a 12 V output from a 40 V input.

Referring to the waveforms in FIG. 3, voltages V_{Cfly1} and V_{Cfly2} are voltages across the flying capacitors C_{fly1} and C_{fly2}, respectively, in the power converter 103 when the modulation technique shown in FIG. 2 is applied. Voltages v_{sw1} and v_{sw2} are voltages across the SR switches SR₁ and SR₂, respectively. These two voltages are also referred to as switching-node voltages in this disclosure. Currents i_{L1} and i_{L2} are currents through the output inductors L₁ and L₂, respectively.

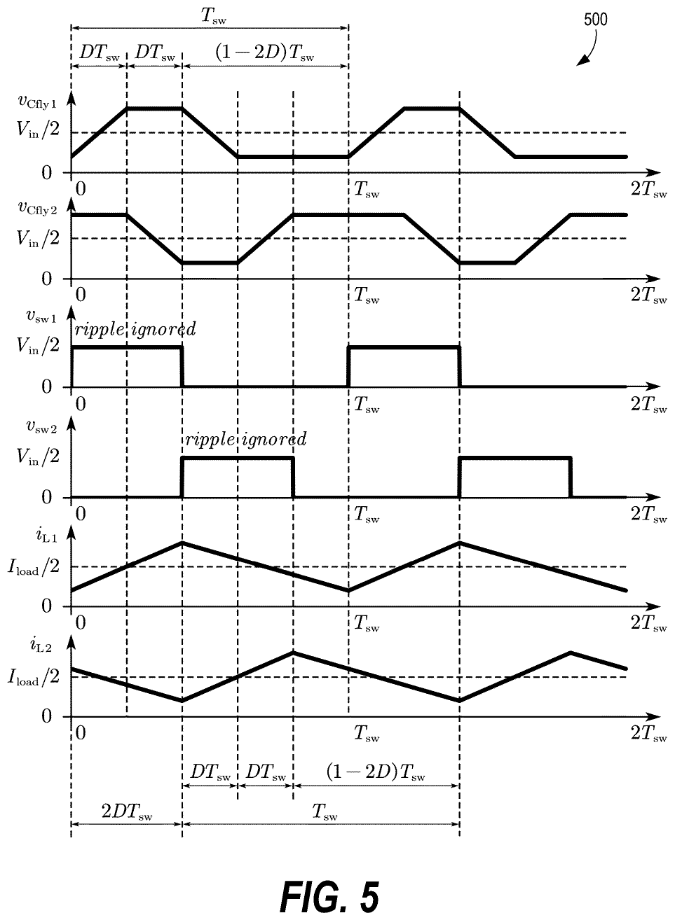

FIG. 4 depicts a timing diagram 400 of switching control signals of a first modulation technique applied to the power converter shown in FIG. 1, and FIG. 5 depicts voltage and current waveforms 500 of various components in the power converter shown in FIG. 1 with the first modulation technique applied, according to one or more embodiments of the present disclosure. The controller 101 shown in FIG. 1 can be configured to generate and apply switching control signals, as represented in the timing diagram 400, to the power converter 103 for converting the input voltage Vᵢₙ to the output voltage Vₒᵤₜ. The switching control signals correspond to a first PWM modulation technique, and the timing diagram 400 corresponds to an implementation of a conversion ratio M of one-fifth for the power converter 103. For the first phase leg of the power converter 103, the controller 101 can be configured to generate a switching control signal 403 for application to the switch Q₁, generate a switching control signal 406 for application to the switch Q₄, and generate a switching control signal 409 for application to the switch SR₁. For the second phase leg of the power converter 103, the controller 101 can be configured to generate a switching control signal 412 for application to the switch Q₃, generate a switching control signal 415 for application to the switch Q₂, and generate a switching control signal 418 for application to the switch SR₂.

The switching control signals 403, 406, 409, 412, 415, and 418 each activate or turn on and turn off respective switches during one or more switching cycles T_{sw(s)} of the power converter 103, as depicted. With respect to one switching cycle T_{sw}, the controller 101 is configured to turn on the switches Q₁, Q₄, and SR₁ of the first phase leg with a time shift or phase shift from the switches Q₃, Q₂, and SR₂ of the second phase leg. In other words, corresponding switches of each phase leg, such as the switches Q₁ and Q₃, Q₄ and Q₂, and SR₁ and SR₂, are time shifted by a multiple of a duty ratio D and the switching period T_{sw} of the power converter 103. For this first modulation technique, the corresponding switches of each phase leg are time shifted by 2DT_{sw}. To delineate, in the switching period T_{sw}, the corresponding switches Q₁ and Q₃ are turned on with a phase shift or time shift of 2DT_{sw} from each other. Additionally, the corresponding switches Q₄ and Q₂ are turned on with a time shift of 2DT_{sw} from each other, and the corresponding switches SR₁ and SR₂ are turned on with a time shift of 2DT_{sw} from each other.

The controller 101 is also configured to sequentially turn on the switches Q₁, Q₄, and SR₁ of the first phase leg in successive order in the switching period T_{sw} as depicted, starting with the switch Q₁, then the switch Q₄, and then the switch SR₁. The controller 101 is also configured to sequentially turn on the switches Q₃, Q₂, and SR₂ of the second phase leg in successive order in the switching period T_{sw} as depicted, starting with the switch Q₃, then the switch Q₂, and then the switch SR₂. The switches SR₁ and SR₂ are complementary to the other switches of their respective phase legs. For example, the controller 101 is configured to turn on the switch SR₁ between the on-time windows of the switches Q₁ and/or Q₄. The controller 101 is configured to turn on switch SR₂ between the on-time windows of the switches Q₃ and/or Q₂. In other words, the on-time windows of the switch SR₁ and the on-time windows of the switches Q₁ and Q₄ do not overlap. Similarly, the on-time windows of the switch SR₂ and the on-time windows of the switches Q₃ and Q₂ do not overlap. The turn-on sequence for the “Q” switches as shown in the timing diagram 400, executed by the controller 101, is Q₁-Q₄-Q₃-Q₂.

The conversion ratio of the input voltage Vin to the output voltage Vₒᵤₜ is represented by equation 3 below, when the first modulation technique is applied to the power converter 103:

$${M}_{pwm 1} = \frac{{V}_{out}}{{V}_{i n}} = {D}_{pwm 1} \qquad ( 3 )$$

The maximum duty ratio is represented by equation 4:

$${D}_{m ax , pwm 1} = \frac{1}{3} , \qquad ( 4 )$$

since the switches Q₃ and Q₁ should not be conducting at the same time. Otherwise, the off-state voltage stress of the switch SR₂ would be the full input voltage Vin rather than half of input voltage Vᵢₙ. Thus, according to equations 3 and 4, the maximum conversion ratio is one-third with the first modulation technique. The voltage and current waveforms 500 in FIG. 5 represent waveforms when a conversion ratio of the input voltage Vᵢₙ to the output voltage Vₒᵤₜ of one-fifth has been applied with respect to the first modulation technique shown in the timing diagram 400.

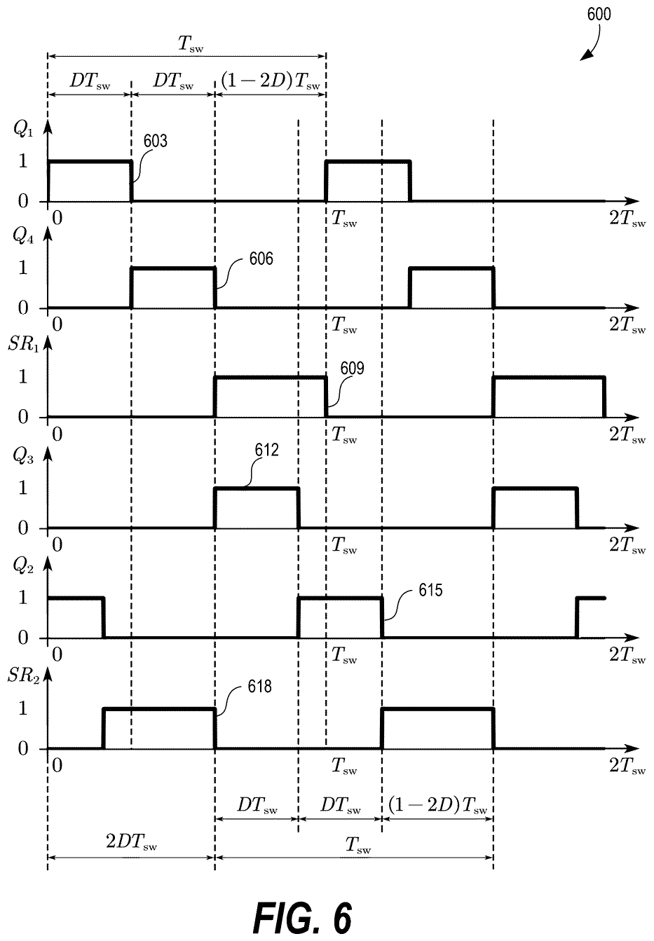

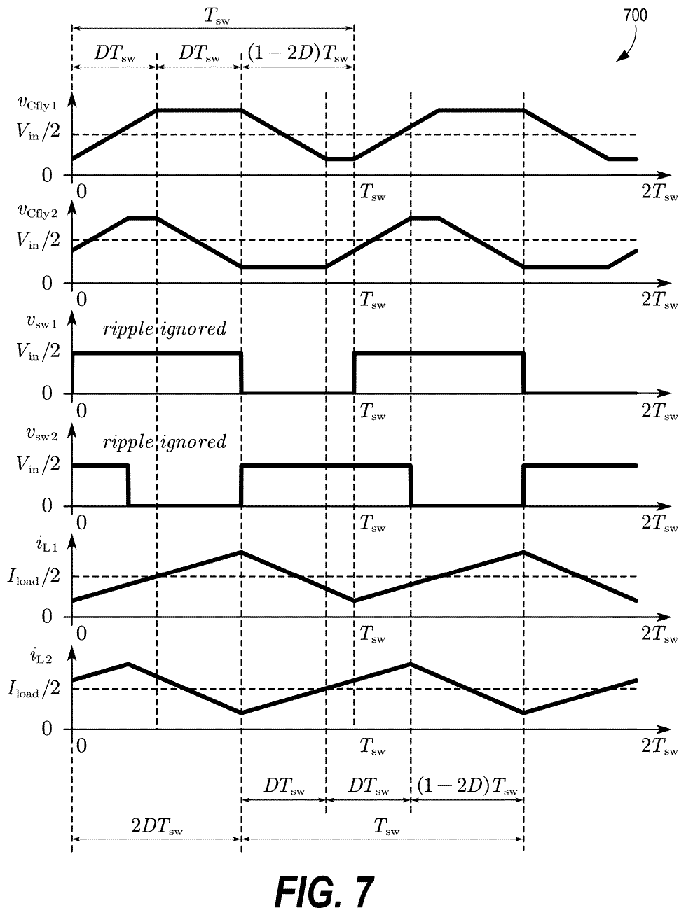

FIG. 6 depicts a timing diagram 600 of switching control signals of the first modulation technique for a different conversion ratio and applied to the power converter shown in FIG. 1, and FIG. 7 depicts voltage and current waveforms 700 of various components in the power converter shown in FIG. 1 with the first modulation technique shown in FIG. 6 applied, according to one or more embodiments of the present disclosure. The controller 101 shown in FIG. 1 can be configured to generate and apply switching control signals shown in the timing diagram 600 to the power converter 103 for converting the input voltage Vᵢₙ to the output voltage Vₒᵤₜ. The switching control signals correspond to the first PWM modulation technique but for a different conversion ratio as compared to the switching control signals shown in the timing diagram 400. The timing diagram 600 corresponds to an implementation of a conversion ratio M of three-tenths for the power converter 103. The modulation technique shown in FIGS. 4 and 6 are identical except the duty ratio D and the resulting conversion ratio M are different. For example, application of the first modulation technique according to the timing diagram 600 can result in a conversion ratio of three-tenths for the power converter 103. The timing diagram 600 shows that the first modulation technique can be applied for any conversion ratio between zero and one-third. In contrast, the conventional modulation technique shown in FIG. 2 cannot achieve a conversion ratio from one-fourth to one-third.

For the first phase leg of the power converter 103, the controller 101 can be configured to generate a switching control signal 603 for application to the switch Q₁, generate a switching control signal 606 for application to the switch Q₄, and generate a switching control signal 609 for application to the switch SR₁. For the second phase leg of the power converter 103, the controller 101 can be configured to generate a switching control signal 612 for application to the switch Q₃, generate a switching control signal 615 for application to the switch Q₂, and generate a switching control signal 618 for application to the switch SR₂.

The switching control signals 603, 606, 609, 612, 615, and 618 each activate or turn on and turn off respective switches during one or more switching cycles T_{sw(s)} of the power converter 103, as depicted. As mentioned earlier, the modulation technique shown by the way of the timing diagrams 400 and 600 are identical with the exception of the duty ratio D and the resulting conversion ratio M. Thus, the turn-on sequence of the switches of the first phase leg and the second phase leg of the power converter 103 shown in the timing diagram 600 is the same as the turn-on sequence shown in the timing diagram 400. Furthermore, the time shift between corresponding switches of the first phase leg and the second phase leg are identical (e.g., 2DT_{sw}) between the timing diagrams 400 and 600.

The voltage and current waveforms 700 in FIG. 7 represent waveforms when a conversion ratio of the input voltage Vᵢₙ to the output voltage Vₒᵤₜ of three-tenths has been applied with respect to the first modulation technique shown in the timing diagram 600.

As compared to the conventional modulation technique shown in FIG. 2, which includes concurrent activation of the switches Q₁ and Q₄ and Q₃ and Q₂, the first modulation technique according to the embodiments do not include concurrent activation of the switches Q₁ and Q₄ and Q₃ and Q₂. Concurrent activation of the switches Q₁ and Q₄ and Q₃ and Q₂ can result in a low-resistance path including Vᵢₙ, Q₁, C_{fly1}, Q₄, C_{fy2} and SR₂. Although the sum of the DC (i.e. average) values of the flying capacitor voltages v_{Cfly1} and V_{Cfly2} is equal to the input voltage Vᵢₙ, the voltage ripples on input capacitors and flying capacitors induce large exponentially decaying current flowing through the low-resistance path, which generates large conduction loss.

This conduction loss, also called charge-sharing loss, originates from the parallel connection of branches including voltages sources and capacitors. In the case of the conventional modulation shown in FIG. 2, the branch of Vᵢₙ and C_{fly1} and the branch of C_{fly2} are connected in parallel when Q₁ and Q₄ are on simultaneously. In the first modulation technique shown by way of the timing diagrams 400 and 600, the conduction windows of Q₁ and Q₄ are not overlapped, and Q₄ is turned on immediately after Q₁ is turned off. In a practical implementation of the first modulation technique, Q₄ can be turned on slightly before Q₁ is turned off, such as ten nanoseconds, which not only keeps the charge-sharing loss small but also ensures the voltages across C_{fly1} and C_{fly2} to be half of the input voltage Vᵢₙ. This technique in a practical implementation applies to Q₂ and Q₃, which means Q₂ can be turned on slightly before Q₃ is turned off, such as ten nanoseconds. As a result, the first modulation technique shown by way of the timing diagrams 400 and 600 has lower charge-sharing loss and higher efficiency than the conventional modulation technique shown in FIG. 2.

It should be noted that the duration of the extremely short overlap time, such as ten nanoseconds between Q₁ and Q₄ and between Q₂ and Q₃ in the disclosed first modulation technique, is independent of converter conversion ratios. As opposed to the overlap time being equal to the whole switch conduction time DT_{sw}, the extremely short overlap time (i.e. zero, or just ten nanoseconds) in the first modulation technique reduces the charge-sharing loss substantially. For example, when the power converter 103 is operated with a 200 kHz switching frequency and the required conversion ratio is one-fifth, the overlap time of Q₁ and Q₄ in the conventional modulation technique (i.e., FIG. 2) is two microseconds. In contrast, the overlap time in the first modulation technique can be zero or just approximately ten nanoseconds which is only one two-hundredth of two microseconds.

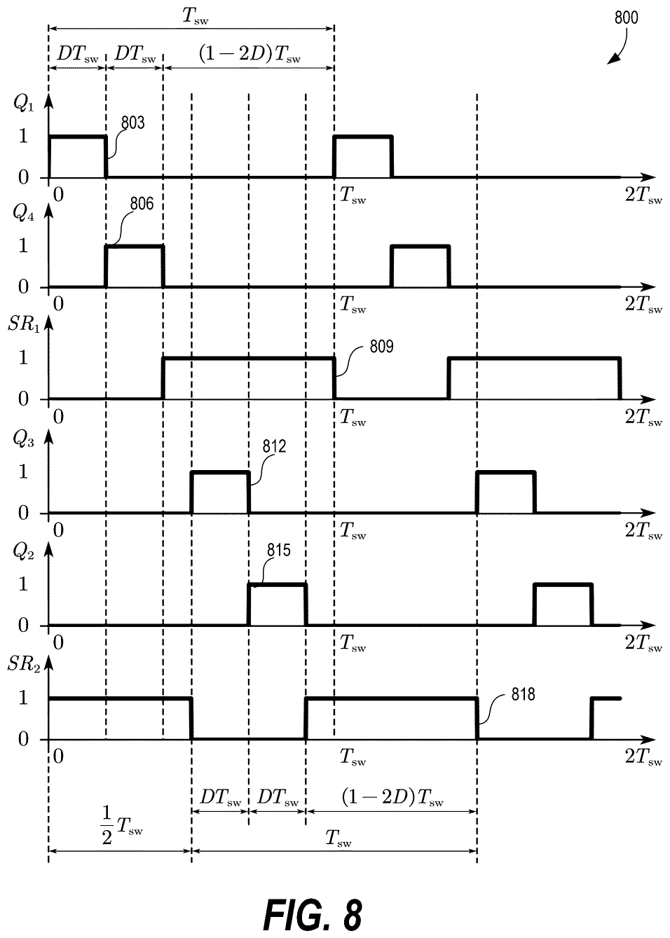

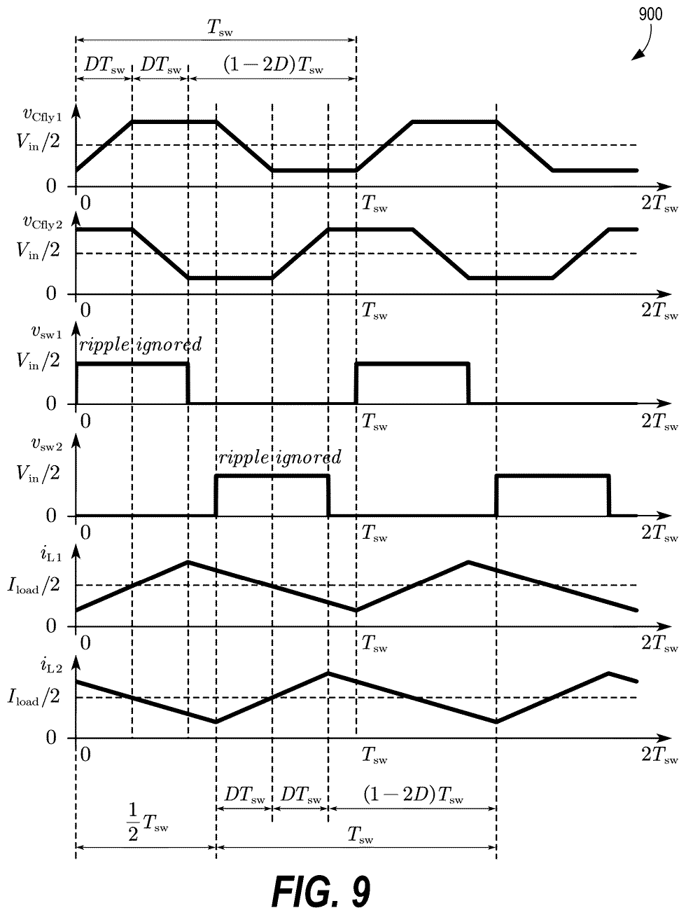

FIG. 8 depicts a timing diagram 800 of switching control signals of a second modulation technique applied to the power converter shown in FIG. 1, and FIG. 9 depicts voltage and current waveforms of various components in the power converter shown in FIG. 1 with the second modulation technique shown in FIG. 8 applied, according to one or more embodiments of the present disclosure. The controller 101 shown in FIG. 1 can be configured to generate and apply switching control signals shown in the timing diagram 800 to the power converter 103 for converting the input voltage Vᵢₙ to the output voltage Vₒᵤₜ. The switching control signals correspond to a second PWM modulation technique, and the timing diagram 800 corresponds to an implementation of a conversion ratio M of one-fifth for the power converter 103. For the first phase leg of the power converter 103, the controller 101 can be configured to generate a switching control signal 803 for application to the switch Q₁, generate a switching control signal 806 for application to the switch Q₄, and generate a switching control signal 809 for application to the switch SR₁. For the second phase leg of the power converter 103, the controller 101 can be configured to generate a switching control signal 812 for application to the switch Q₃, generate a switching control signal 815 for application to the switch Q₂, and generate a switching control signal 818 for application to the switch SR₂.

The switching control signals 803, 806, 809, 812, 815, and 818 each activate or turn on and turn off respective switches during one or more switching cycles T_{sw(s)} of the power converter 103, as depicted. With respect to one switching cycle T_{sw}, the controller 101 is configured to turn on the switches Q₁, Q₄, and SR₁ of the first phase leg with a time shift or phase shift from the switches Q₃, Q₂, and SR₂ of the second phase leg. In other words, corresponding switches of each phase leg, such as the switches Q₁ and Q₃, Q₄ and Q₂, and SR₁ and SR₂, are time shifted by a multiple of the switching period T_{sw} of the power converter 103. For this second modulation technique, the corresponding switches of each phase leg are time shifted by T_{sw}/2. To delineate, in the switching period T_{sw}, the corresponding switches Q₁ and Q₃ are turned on with a phase shift or time shift of T_{sw}/2 from each other. Additionally, the corresponding switches Q₄ and Q₂ are turned on with a time shift of T_{sw}/2 from each other, and the corresponding switches SR₁ and SR₂ are turned on with a time shift of T_{sw}/2 from each other.

The controller 101 is also configured to sequentially turn on the switches Q₁, Q₄, and SR₁ of the first phase leg in successive order in the switching period T_{sw} as depicted, starting with the switch Q₁, then the switch Q₄, and then the switch SR₁. The controller 101 is also configured to sequentially turn on the switches Q₃, Q₂, and SR₂ of the second phase leg in successive order in the switching period T_{sw} as depicted, starting with the switch Q₃, then the switch Q₂, and then the switch SR₂. The switches SR₁ and SR₂ are complementary to the other switches of their respective phase legs. For example, the controller 101 is configured to turn on the switch SR₁ between the on-time windows of the switches Q₁ and/or Q₄. The controller 101 is configured to turn on switch SR₂ between the on-time windows of the switches Q₃ and/or Q₂. In other words, the on-time windows of the switch SR₁ and the on-time windows of the switches Q₁ and Q₄ do not overlap. Similarly, the on-time windows of the switch SR₂ and the on-time windows of the switches Q₃ and Q₂ do not overlap. The turn-on sequence for the “Q” switches as shown in the timing diagram 800, executed by the controller 101, is Q₁-Q₄-Q₃-Q₂.

The conversion ratio of the input voltage Vᵢₙ to the output voltage Vₒᵤₜ is represented by equation 5 below, when the second modulation technique is applied to the power converter 103:

$${M}_{pwm 2} = \frac{{V}_{out}}{{V}_{i n}} = {D}_{pwm 2} \qquad ( 5 )$$

The maximum duty ratio is represented by equation 6:

$${D}_{m ax , pwm 2} = \frac{1}{3} \qquad ( 6 )$$

since the switches Q₃ and Q₁ should not be conducting at the same time. Otherwise, the off-state voltage stress of the switch SR₂ would be the full input voltage Vᵢₙ rather than half of input voltage Vᵢₙ. Thus, according to equations 5 and 6, the maximum conversion ratio is one-third with the application of the second modulation technique.

The voltage and current waveforms 900 in FIG. 9 represent waveforms when a conversion ratio of the input voltage Vᵢₙ to the output voltage Vₒᵤₜ of one-fifth has been applied with respect to the second modulation technique shown in the timing diagram 800.

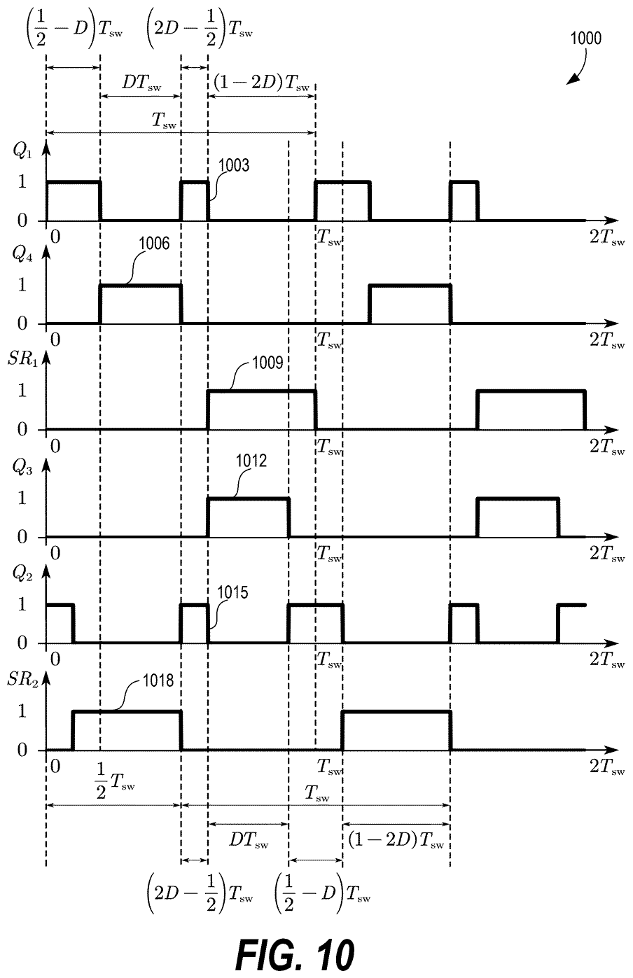

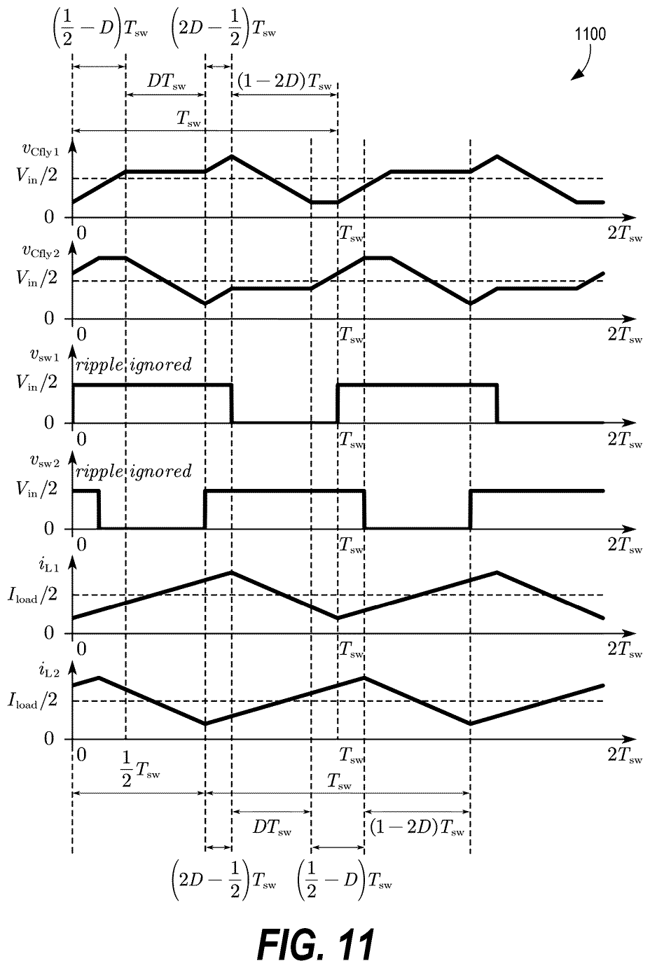

FIG. 10 depicts a timing diagram 1000 of switching control signals of the second modulation technique for a different conversion ratio and applied to the power converter shown in FIG. 1, and FIG. 11 depicts voltage and current waveforms 1100 of various components in the power converter shown in FIG. 1 with the second modulation technique shown in FIG. 10 applied, according to one or more embodiments of the present disclosure. The controller 101 shown in FIG. 1 can be configured to generate and apply switching control signals shown in the timing diagram 1000 to the power converter 103 for converting the input voltage Vᵢₙ to the output voltage Vₒᵤₜ. The switching control signals correspond to the second PWM modulation technique but for a different conversion ratio as compared to the switching control signals shown in the timing diagram 800. The second modulation technique according to the timing diagram 800 can be relied upon when the required voltage conversion ratio is between zero and one-fourth. The second modulation technique according to the timing diagram 1000 shown in FIG. 10 can be relied upon when the required voltage conversion ratio is between one-fourth and one-third. The constituents of the second modulation technique according to the timing diagrams 800 and 1000 are shown below as equation 7:

$$PWM 2 \{ \begin{matrix}PWM 2 a ( 0 < M ⩽ 1 / 4 ) \\ PWM 2 b ( 1 / 4 ⩽ M < 1 / 3 )\end{matrix} \qquad ( 7 )$$

In the above equation, PWM2 corresponds to the second modulation technique, PWM2a corresponds to the second modulation technique according to the timing diagram 800, and PWM2b corresponds to the second modulation technique according to the timing diagram 1000.

For the first phase leg of the power converter 103, the controller 101 can be configured to generate a switching control signal 1003 for application to the switch Q₁, generate a switching control signal 1006 for application to the switch Q₄, and generate a switching control signal 1009 for application to the switch SR₁. For the second phase leg of the power converter 103, the controller 101 can be configured to generate a switching control signal 1012 for application to the switch Q₃, generate a switching control signal 1015 for application to the switch Q₂, and generate a switching control signal 1018 for application to the switch SR₂.

The switching control signals 1003, 1006, 1009, 1012, 1015, and 1018 each activate or turn on and turn off respective switches during one or more switching cycles T_{sw(s)} of the power converter 103, as depicted. In contrast with the second modulation technique shown in the timing diagram 800, the controller 101 is configured to turn on and/or turn off the switch Q₁ of the first phase leg and the switch Q₂ of the second phase leg twice in the switching period T_{sw}. For example, for the switching control signal 1003, the switch Q₁ turns on twice and turns off twice in the switching period T_{sw}. For the switching control signal 1015, the switch Q₂ turns on twice and turns off twice in the switching period T_{sw}. The time shift between corresponding switches of the first phase leg and the second phase leg are identical (e.g., T_{sw}/2) between the timing diagrams 800 and 1000.

For a conversion ratio of one-fourth, either of the second modulation techniques according to the timing diagrams 800 or 1000 (e.g., PWM2a or PWM2b according to equation 7) can be applied since they converge to an identical modulation. Therefore, the modulation transition is smooth, and there is no abrupt change in the operations of the switches of the power converter 103 during transition.

The voltage and current waveforms 1100 in FIG. 11 represent waveforms when a conversion ratio of the input voltage Vᵢₙ to the output voltage Vₒᵤₜ of three-tenths has been applied with respect to the second modulation technique shown in the timing diagram 1000.

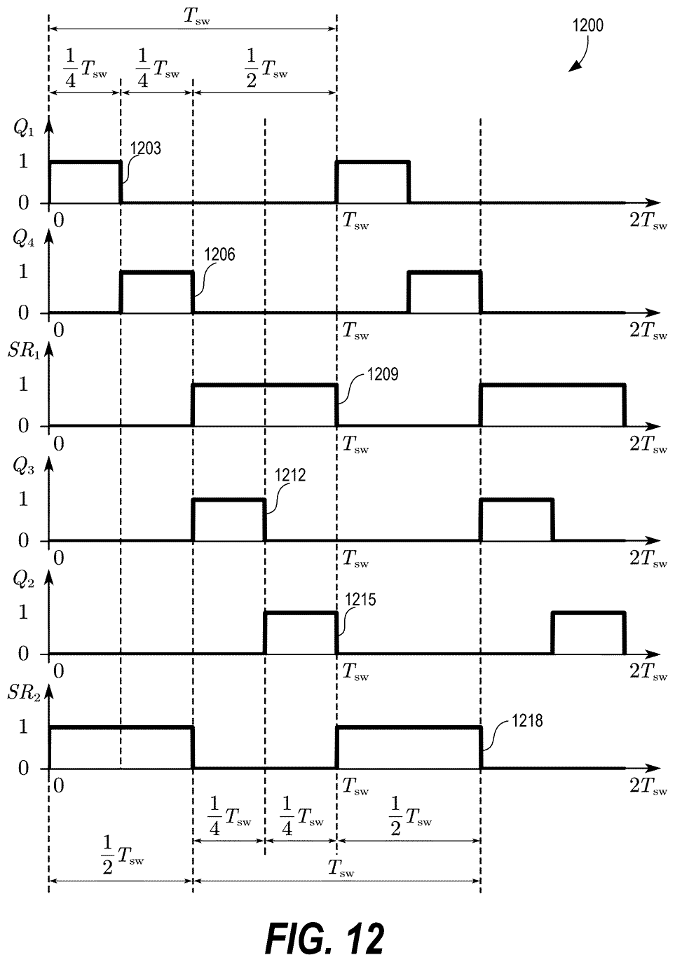

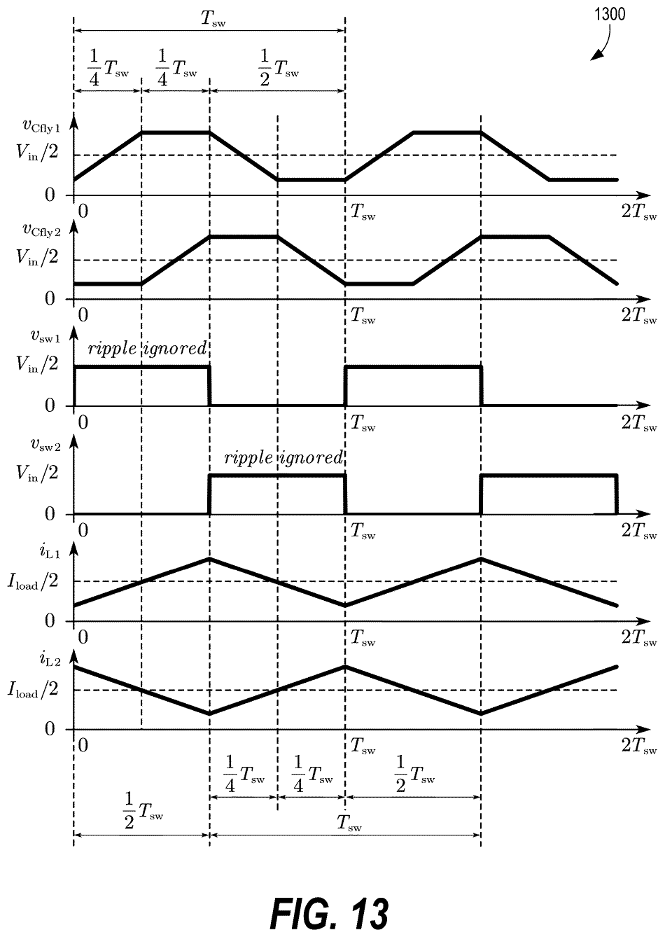

FIG. 12 depicts a timing diagram 1200 of switching control signals of the second modulation technique for a different conversion ratio and applied to the power converter shown in FIG. 1, and FIG. 13 depicts voltage and current waveforms 1300 of various components in the power converter shown in FIG. 1 with the second modulation technique shown in FIG. 12 applied, according to one or more embodiments of the present disclosure. The controller 101 shown in FIG. 1 can be configured to generate and apply switching control signals shown in the timing diagram 1200 to the power converter 103 for converting the input voltage Vᵢₙ to the output voltage Vₒᵤₜ. The switching control signals correspond to the second PWM modulation technique but for a different conversion ratio as compared to the switching control signals shown in the timing diagrams 800 and 1000. The second modulation technique according to the timing diagram 1200 can be relied upon when the required voltage conversion ratio is one fourth for the power converter 103.

For the first phase leg of the power converter 103, the controller 101 can be configured to generate a switching control signal 1203 for application to the switch Q₁, generate a switching control signal 1206 for application to the switch Q₄, and generate a switching control signal 1209 for application to the switch SR₁. For the second phase leg of the power converter 103, the controller 101 can be configured to generate a switching control signal 1212 for application to the switch Q₃, generate a switching control signal 1215 for application to the switch Q₂, and generate a switching control signal 1218 for application to the switch SR₂.

The switching control signals 1203, 1206, 1209, 1212, 1215, and 1218 each activate or turn on and turn off respective switches during one or more switching cycles T_{sw(s)} of the power converter 103, as depicted. Similar to the second modulation technique shown in the timing diagrams 800 and 1000, the time shift for the second modulation technique shown in the timing diagram 1200 between corresponding switches (e.g., Q₁ and Q₃, Q₄ and Q₂, and SR₁ and SR₂, etc.) of the first phase leg and the second phase leg are identical (e.g., T_{sw}/2).

The voltage and current waveforms 1300 in FIG. 13 represent waveforms when a conversion ratio of the input voltage Vᵢₙ to the output voltage Vₒᵤₜ of one-fourth has been applied with respect to the second modulation technique shown in the timing diagram 1200. Additionally, the first modulation technique represented by the timing diagrams 400 and 600, if the required conversion ratio is one-fourth, would show similar voltage and current waveforms as the voltage and current waveforms 1300. This is because the first modulation technique and the second modulation technique according to the embodiments converge to a similar or identical modulation when the required conversion ratio is one-fourth.

The controller 101 is also configured to sequentially turn on the switches Q₁, Q₄, and SR₁ of the first phase leg in successive order in the switching period T_{sw} as depicted, starting with the switch Q₁, then the switch Q₄, and then the switch SR₁. The controller 101 is also configured to sequentially turn on the switches Q₃, Q₂, and SR₂ of the second phase leg in successive order in the switching period T_{sw} as depicted, starting with the switch Q₃, then the switch Q₂, and then the switch SR₂. The switches SR₁ and SR₂ are complementary to the other switches of their respective phase legs. For example, the controller 101 is configured to turn on the switch SR₁ between the on-time windows of the switches Q₁ and/or Q₄. The controller 101 is configured to turn on switch SR₂ between the on-time windows of the switches Q₃ and/or Q₂. In other words, the on-time windows of the switch SR₁ and the on-time windows of the switches Q₁ and Q₄ do not overlap. Similarly, the on-time windows of the switch SR₂ and the on-time windows of the switches Q₃ and Q₂ do not overlap. The turn-on sequence for the “Q” switches as shown in the timing diagram 1200, executed by the controller 101, is Q₁-Q₄-Q₃-Q₂.

Similar to the first modulation technique shown in the timing diagrams 400 and 600, in a practical implementation of the second modulation technique shown in the timing diagrams 800, 1000, and 1200, Q₄ can be turned on slightly before Q₁ is turned off, such as approximately ten nanoseconds, which not only keeps the charge-sharing loss small but also ensures the voltages across flying capacitors C_{fly1} and C_{fly2} to be half of the input voltage Vᵢₙ. The same technique also applies to Q₂ and Q₃, which means that Q₂ can be turned on slightly before Q₃ is turned off, such as approximately ten nanoseconds. It should be noted that the duration of the extremely short overlap time, such as ten nanoseconds between Q₁ and Q₄ and between Q₂ and Q₃ in the second modulation technique, is independent of converter conversion ratios.

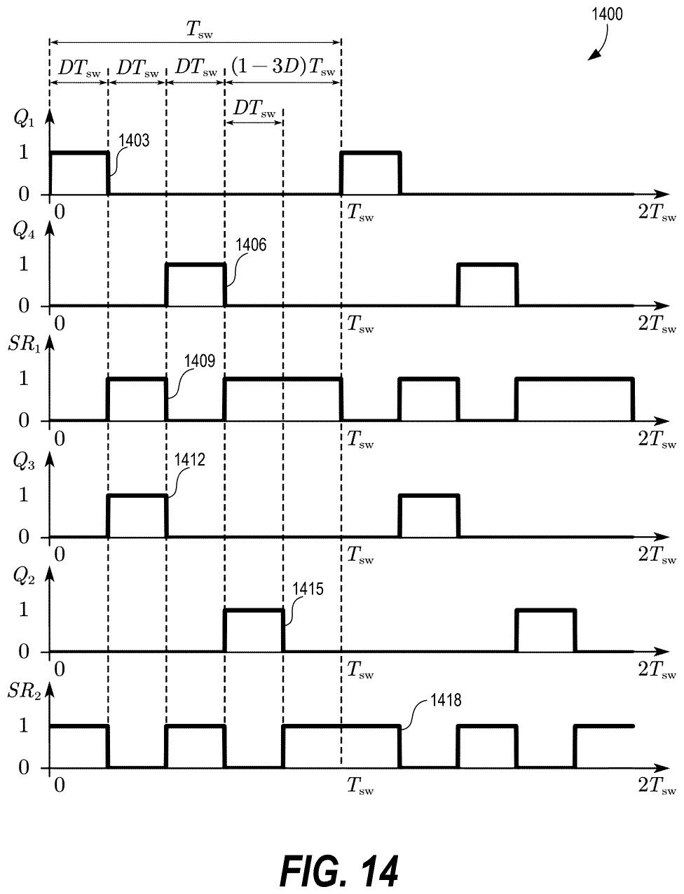

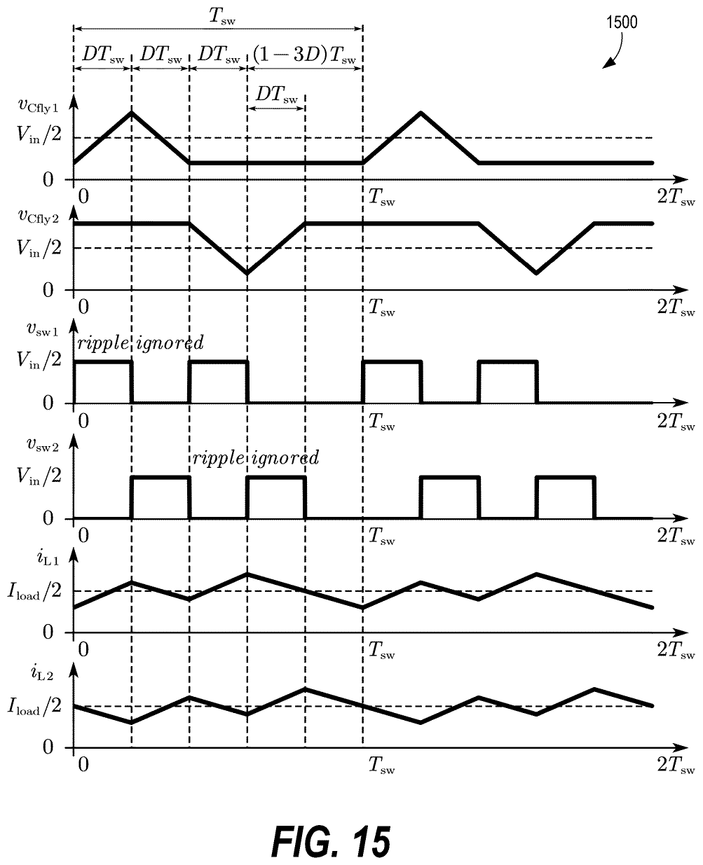

FIG. 14 depicts a timing diagram 1400 of switching control signals of a third modulation technique applied to the power converter shown in FIG. 1, and FIG. 15 depicts voltage and current waveforms 1500 of various components in the power converter shown in FIG. 1 with the third modulation technique applied, according to one or more embodiments of the present disclosure. The controller 101 shown in FIG. 1 can be configured to generate and apply switching control signals, as represented in the timing diagram 1400, to the power converter 103 for converting the input voltage Vᵢₙ to the output voltage Vₒᵤₜ. The switching control signals correspond to a third PWM modulation technique, and the timing diagram 1400 corresponds to an implementation of a conversion ratio M of one-fifth for the power converter 103. For the first phase leg of the power converter 103, the controller 101 can be configured to generate a switching control signal 1403 for application to the switch Q₁, generate a switching control signal 1406 for application to the switch Q₄, and generate a switching control signal 1409 for application to the switch SR₁. For the second phase leg of the power converter 103, the controller 101 can be configured to generate a switching control signal 1412 for application to the switch Q₃, generate a switching control signal 1415 for application to the switch Q₂, and generate a switching control signal 1418 for application to the switch SR₂.

The switching control signals 1403, 1406, 1409, 1412, 1415, and 1418 each activate or turn on and turn off respective switches during one or more switching cycles T_{sw(s)} of the power converter 103, as depicted. With respect to one switching cycle T_{sw}, the controller 101 is configured to turn on the switches Q₁, Q₄, and SR₁ of the first phase leg with a time shift or phase shift from the switches Q₃, Q₂, and SR₂ of the second phase leg. In other words, corresponding switches of each phase leg, such as the switches Q₁ and Q₃, Q₄ and Q₂, and SR₁ and SR₂, are time shifted by a multiple of a duty ratio D and the switching period T_{sw} of the power converter 103. For this third modulation technique, the corresponding switches of each phase leg are time shifted by DT_{sw}. To delineate, in the switching period T_{sw}, the corresponding switches Q₁ and Q₃ are turned on with a phase shift or time shift of DT_{sw} from each other. Additionally, the corresponding switches Q₄ and Q₂ are turned on with a time shift of DT_{sw} from each other, and the corresponding switches SR₁ and SR₂ are turned on with a time shift of DT_{sw} from each other.

The controller 101 is configured to sequentially turn on the switch Q₁ of the first phase leg and Q₃ of the second phase leg in successive order in the switching period T_{sw} as depicted. Next, the controller 101 is further configured to sequentially turn on the switch Q₄ of the first phase leg and Q₂ of the second phase leg in successive order in the switching period T_{sw} as depicted, after sequentially turning on the switch Q₁ of the first phase leg and Q₃ of the second phase leg. The switches SR₁ and SR₂ are complementary to the other switches of their respective phase legs. For example, the controller 101 is configured to turn on the switch SR₁ between the on-time windows of the switches Q₁ and/or Q₄. The controller 101 is configured to turn on the switch SR₂ between the on-time windows of the switches Q₃ and/or Q₂. In other words, the on-time windows of the switch SR₁ and the on-time windows of the switches Q₁ and Q₄ do not overlap. Similarly, the on-time windows of the switch SR₂ and the on-time windows of the switches Q₃ and Q₂ do not overlap.

The controller 101 is configured to turn on and/or turn off the switch SR₁ of the first phase leg twice and turn on and/or turn off the switch SR₂ of the second phase leg twice in the switching period T_{sw}. For example, for the switching control signal 1409, the switch SR₁ turns on twice and turns off twice in the switching period T_{sw}. For the switching control signal 1418, the switch SR₂ turns on twice and turns off twice in the switching period T_{sw}. The turn-on sequence for the “Q” switches as shown in the timing diagram 1400, executed by the controller 101, is Q₁-Q₃-Q₄-Q₂. The third modulation technique according to the timing diagram 1400 can be applied with any duty ratio between zero and one-third and correspondingly for any conversion ratio between zero and one-third.

The voltage and current waveforms 1500 in FIG. 15 represent waveforms when a conversion ratio of the input voltage Vᵢₙ to the output voltage Vₒᵤₜ of one-fifth has been applied with respect to the third modulation technique shown in the timing diagram 1400.

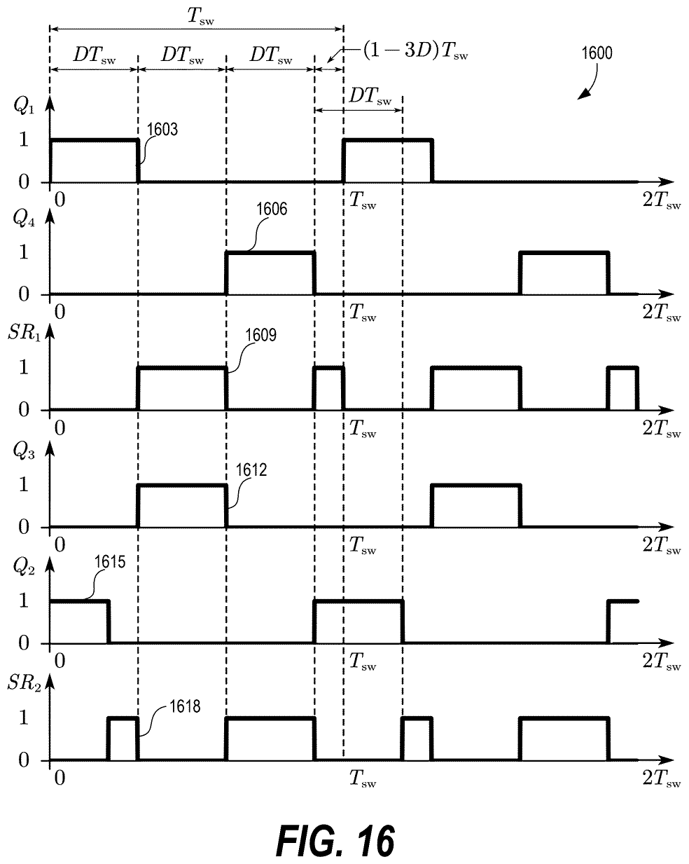

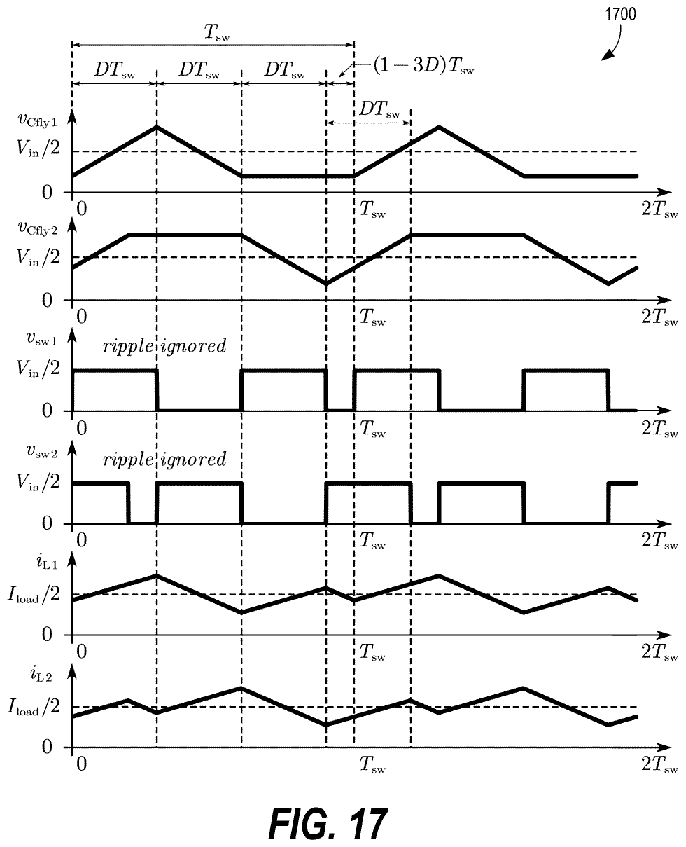

FIG. 16 depicts a timing diagram 1600 of switching control signals of the third modulation technique for a different conversion ratio and applied to the power converter shown in FIG. 1, and FIG. 17 depicts voltage and current waveforms 1700 of various components in the power converter shown in FIG. 1 with the third modulation technique shown in FIG. 16 applied, according to one or more embodiments of the present disclosure. The controller 101 shown in FIG. 1 can be configured to generate and apply switching control signals shown in the timing diagram 1600 to the power converter 103 for converting the input voltage Vᵢₙ to the output voltage Vₒᵤₜ. The switching control signals correspond to the third PWM modulation technique but for a different conversion ratio as compared to the switching control signals shown in the timing diagram 1400. The third modulation technique according to the timing diagram 1600 can be relied upon when the required voltage conversion ratio is three-tenths.

For the first phase leg of the power converter 103, the controller 101 can be configured to generate a switching control signal 1603 for application to the switch Q₁, generate a switching control signal 1606 for application to the switch Q₄, and generate a switching control signal 1609 for application to the switch SR₁. For the second phase leg of the power converter 103, the controller 101 can be configured to generate a switching control signal 1612 for application to the switch Q₃, generate a switching control signal 1615 for application to the switch Q₂, and generate a switching control signal 1618 for application to the switch SR₂.

The switching control signals 1603, 1606, 1609, 1612, 1615, and 1618 each activate or turn on and turn off respective switches during one or more switching cycles T_{sw(s)} of the power converter 103, as depicted. Similar to the third modulation technique shown in the timing diagram 1400, the controller 101 is configured to turn on and/or turn off the switch SR₁ of the first phase leg twice and turn on and/or turn off twice the switch SR₂ of the second phase leg twice in the switching period T_{sw}. For example, for the switching control signal 1609, the switch SR₁ turns on twice and turns off twice in the switching period T_{sw}. For the switching control signal 1618, the switch SR₂ turns on twice and turns off twice in the switching period T_{sw}. The time shift between corresponding switches of the first phase leg and the second phase leg are identical (e.g., DT_{sw}) between the timing diagrams 1400 and 1600.

The switches SR₁ and SR₂ are complementary to the other switches of their respective phase legs. For example, the controller 101 is configured to turn on the switch SR₁ between the on-time windows of the switches Q₁ and/or Q₄. The controller 101 is configured to turn on the switch SR₂ between the on-time windows of the switches Q₃ and/or Q₂. In other words, the on-time windows of the switch SR₁ and the on-time windows of the switches Q₁ and Q₄ do not overlap. Similarly, the on-time windows of the switch SR₂ and the on-time windows of the switches Q₃ and Q₂ do not overlap. The turn-on sequence for the “Q” switches as shown in the timing diagram 1600, executed by the controller 101, is Q₁-Q₃-Q₄-Q₂. It should be noted that the third modulation technique as represented by the timing diagrams 1400 and 1600 are identical with the exception of the duty ratio D and the resulting conversion ratio M.

The voltage and current waveforms 1700 in FIG. 17 represent waveforms when a conversion ratio of the input voltage Vᵢₙ to the output voltage Vₒᵤₜ of three-tenths has been applied with respect to the third modulation technique shown in the timing diagram 1600. For the same switching frequency of the power converter 103, application of the third modulation technique results in smaller inductor current ripples as compared to those of the first and the second modulation techniques.

It should be understood that the timing diagrams and waveforms shown in FIGS. 4-17 are exemplary and idealized, and that the actual waveforms usually contain noises. Non-ideal component characteristics and trace impedances of PCB implementations affect the appearance of the measured waveforms. As mentioned previously, in a practical implementation of the disclosed modulations, there can be a very short overlap time between Q₁ and Q₄ and a very short overlap time between Q₂ and Q₃. Further, dead times are usually inserted before SR switches turn on and after they turn off, which are standard operations in the field of DC to DC converters. These practical implementations also affect the appearance of the measured waveforms, as one of ordinary skill in the art would understand.

Additionally, the modulation techniques according to the embodiments have inherent voltage balancing mechanisms for flying capacitors and an inherent current balancing mechanism for output inductors. With respect to the first modulation technique shown by way of the timing diagram 400 in FIG. 4 as an example, small-ripple approximations and principles of volt-second balance and charge-balance applications result in the following equations:

$$D ( {V}_{i n} - {V}_{Cfly 1} ) + {D V}_{Cfly 2} = {V}_{out} \qquad ( 8 )$$

$$D ( {V}_{i n} - {V}_{Cfly 2} ) + {D V}_{Cfly 1} = {V}_{out} \qquad ( 9 )$$

$${DI}_{L 1} = {DI}_{L 2} \qquad ( 10 )$$

$${I}_{L 1} + {I}_{L 2} = {I}_{load} \qquad ( 11 )$$

Also, as mentioned previously, in a practical implementation of the disclosed modulations, Q₄ can be turned on approximately ten nanoseconds before Q₁ turns off, and Q₂ can be turned on approximately ten nanoseconds before Q₃ turns off. With the extremely short overlap time applied, equation 12 includes:

$${V}_{Cfly 1} + {V}_{Cfly 2} = {V}_{i n} \qquad ( 12 )$$

Solving the system of the five equations above leads to the equations below:

$${V}_{out} = {D V}_{i n} \qquad ( 13 )$$

$${V}_{Cfly 1} = {V}_{Cfly 2} = \frac{1}{2} {V}_{i n} \qquad ( 14 )$$

$${I}_{L 1} = {I}_{L 1} = \frac{1}{2} {I}_{load} \qquad ( 15 )$$

Therefore, in a two-phase symmetric SCB converter with the disclosed modulations applied, flying capacitor voltages are self-regulated to approximately half of the input voltage, and inductor currents are self-regulated to approximately half of the output current. The inherent balancing mechanism eliminates the needs of sensing high-frequency voltages and currents and external active balancing circuits, which reduces system complexity and cost.

One or more microprocessors, microcontrollers, or DSPs can execute software to perform the control aspects of the embodiments described herein, such as the control aspects performed by the controller 101. Any software or program instructions can be embodied in or on any suitable type of non-transitory computer-readable medium for execution. Example computer-readable mediums include any suitable physical (i.e., non-transitory or non-signal) volatile and non-volatile, random and sequential access, read/write and read-only, media, such as hard disk, floppy disk, optical disk, magnetic, semiconductor (e.g., flash, magneto-resistive, etc.), and other memory devices. Further, any component described herein can be implemented and structured in a variety of ways. For example, one or more components can be implemented as a combination of discrete and integrated analog and digital components.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims. If a component is described as having “one or more” of the component, it is understood that the component can be referred to as “at least one” component.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A power converter system, comprising:
a power converter comprising a first phase leg and a second phase leg, the first phase leg comprising a first plurality of switches comprising a first switch, a second switch, and a third switch, and the second phase leg comprising a second plurality of switches comprising a fourth switch, a fifth switch, and a sixth switch; and
a controller configured to control operations of the power converter for converting an input direct current (DC) voltage to an output DC voltage, the operations comprising, for a switching period of the power converter:
sequentially turning on one or more switches of the first plurality of switches of the first phase leg; and
sequentially turning on one or more switches of the second plurality of switches of the second phase leg after sequentially turning on the one or more switches of the first plurality of switches.

2. The power converter system of claim 1, wherein the power converter is a two-phase symmetric series-capacitor buck (SCB) power converter.

3. The power converter system of claim 1, wherein sequentially turning on the first plurality of switches further comprises turning on the first switch, the second switch, and the third switch in successive order.

4. The power converter system of claim 1, wherein sequentially turning on the second plurality of switches after turning on the first plurality of switches further comprises turning on the fourth switch, the fifth switch, and the sixth switch in successive order.

5. The power converter system of claim 1, wherein a time shift corresponding to a multiple of a duty ratio and the switching period of the power converter separates activation of at least one switch of the first plurality of switches from activation of at least one switch of the second plurality of switches.

6. The power converter system of claim 5, wherein the multiple corresponds to two.

7. The power converter system of claim 1, wherein a time shift corresponding to a multiple of the switching period separates activation of at least one switch of the first plurality of switches from activation of at least one switch of the second plurality of switches.

8. The power converter system of claim 7, wherein the multiple corresponds to one-half.

9. The power converter system of claim 1, wherein:
at least one switch of the first plurality of switches turns on at least twice and turns off at least twice in the switching period while a different switch of the first plurality of switches turns on once and turns off once in the switching period; and
at least one switch of the second plurality of switches turns on at least twice and turns off at least twice in the switching period while a different switch of the second plurality of switches turns on once and turns off once in the switching period.

10. The power converter system of claim 9, wherein:
a first on-time duration of the at least one switch of the first plurality of switches is different from a second on-time duration of the at least one switch of the first plurality of switches; and
a first on-time duration of the at least one switch of the second plurality of switches is different from a second on-time duration of the at least one switch of the second plurality of switches.

11. The power converter system of claim 1, wherein:
each switch of the first plurality of switches turns on once and turns off once in the switching period; and
each switch of the second plurality of switches turns on once and turns off once in the switching period.

12. The power converter system of claim 11, wherein:
an on-time duration of the first switch of the first plurality of switches is the same as an on-time duration of the second switch of the first plurality of switches in the switching period; and
an on-time duration of the fourth switch of the second plurality of switches is the same as an on-time duration of the fifth switch of the second plurality of switches in the switching period.

13. The power converter system of claim 1, wherein:
the third switch of the first plurality of switches is a synchronous rectifier (SR) switch; and
the sixth switch of the second plurality of switches is a SR switch.

14. The power converter system of claim 1, wherein a conversion ratio for converting the input DC voltage to the output DC voltage ranges from zero and up to one-third.

15. A power converter system, comprising:
a power converter comprising a first phase leg and a second phase leg, the first phase leg comprising a first plurality of switches comprising a first switch, a second switch, and a third switch, and the second phase leg comprising a second plurality of switches comprising a fourth switch, a fifth switch, and a sixth switch; and
a controller configured to control operations of the power converter for converting an input direct current (DC) voltage to an output DC voltage, the operations comprising, for a switching period of the power converter:
sequentially turning on the first switch of the first plurality of switches of the first phase leg and the fourth switch of the second plurality of switches of the second phase leg; and
sequentially turning on the second switch of the first plurality of switches and the fifth switch of the second plurality of switches after sequentially turning on the first switch of the first plurality of switches and the fourth switch of the second plurality of switches.

16. The power converter system of claim 15, wherein a time shift corresponding to a multiple of a duty ratio and the switching period of the power converter separates activation of at least one switch of the first plurality of switches from activation of at least one switch of the second plurality of switches.

17. The power converter system of claim 16, wherein the multiple corresponds to one.

18. The power converter system of claim 15, wherein:
at least one switch of the first plurality of switches turns on at least twice and turns off at least twice in the switching period while a different switch of the first plurality of switches turns on once and turns off once in the switching period; and
at least one switch of the second plurality of switches turns on at least twice and turns off at least twice in the switching period while a different switch of the second plurality of switches turns on once and turns off once in the switching period.

19. The power converter system of claim 18, wherein:
the at least one switch of the first plurality of switches is the third switch and the different switch of the first plurality of switches is the first switch or the second switch; and
the at least one switch of the second plurality of switches is the sixth switch and the different switch of the first plurality of switches is the fourth switch or the fifth switch.

20. The power converter system of claim 19, wherein:
the third switch of the first plurality of switches is a synchronous rectifier (SR) switch; and
the sixth switch of the second plurality of switches is a SR switch.
